(19) United States
(12) Patent Application Publication
(10) Pub. No.: US 2021/0329900 A1
(43) Pub. Date: Oct. 28, 2021

(54) SONIC STIMULATION AND DETECTION OF FISH

(71) Applicants: Brent J. Bloemendaal, Zionsville, IL (US); Casey J. Childre, Foley, AL (US)

(72) Inventors: Brent J. Bloemendaal, Zionsville, IL (US); Casey J. Childre, Foley, AL (US)

(21) Appl. No.: 17/240,608

(22) Filed: Apr. 26, 2021

Related U.S. Application Data
(60) Provisional application No. 63/016,743, filed on Apr. 28, 2020.

(51) Int. Cl. A01K 97/12; A01K 85/01; H04R 1/08; H04R 1/02

(52) U.S. Cl. CPC A01K 97/125; H04R 1/028; H04R 1/08; A01K 85/01

(57) ABSTRACT

A sonic stimulation and detection device includes an enclosure mounted on a fishing rod having to a fishing line attached to and extending along the rod. A microphone element is mounted in the enclosure and is acoustically coupled to the line through the enclosure and the rod line to couple sounds of fish contact with the line to the microphone. The microphone may be coupled to a headphone. A sound generator is mounted in the enclosure and is acoustically coupled to the line through the enclosure and the rod to couple fish simulating sounds generated thereby to the line to attract fish to a lure attached to the line. The enclosure is shaped to efficiently couple sounds coupled from the line to the microphone and sounds generated by the sound generator to the line.

### CROSS-REFERENCE TO RELATED APPLICATIONS

This application claims the benefit of provisional patent application Ser. No. 63/016,743, filed Apr. 8, 2020 entitled SONIC STIMULATION AND DETECTION OF FISH, the entirety of which is incorporated herein by reference.

### BACKGROUND OF THE INVENTION

### Field of the Invention

The present invention is broadly concerned with apparatus for fishing and, more particularly, apparatus for sonically stimulating fish to strike a lure and for sonically detecting contact with a fishing line or lure by a fish.

### BACKGROUND & DESCRIPTION OF THE RELATED ART

Fishing is an ancient practice which is principally pursued to provide food for human consumption. Commercial fishing gathers large numbers of fish at a time, usually by drawing nets through schools or other groups of fish. In recreational or sport fishing, the aim is to entice a single fish at a time to strike at, and get snagged by, a hook. The hooked fish may then be harvested for consumption or unhooked and released alive. Typically, a hook is embedded into or through live or food baits or attached to artificial lures to motivate a fish to strike or bite at the bait or lure and, thus, become hooked.

Fishing lures are designed to attract a fish's attention by the use of movement, vibration, flash, appearance, and color. Many lures are equipped with one or more hooks that are used to catch fish when they strike the lure. Most lures are attached to the end of a fishing line and have various styles of hooks attached to the body or frame and are designed to elicit a strike by a fish. Various types of lures have been used since ancient times.

Many types of fish are known to have hearing capabilities which they use to avoid predators and to aid in catching fish, worms, insects, and the like that they prey upon by sounds that such creatures make in moving through water. Fish generate audible turbulence in moving through water and by contact with plants, other fish, and objects in the water.

Various kinds of sonic devices have been used in fishing, such as sonar devices which emit a sound wave from an underwater transducer and detect reflections of the sound to create a two-dimensional image of groups of fish. There have been a number of devices for drawing fish into an area by the use of sounds so that the fish could be caught, as by the use of nets, conventional fishing tackle, and the like. An example of such a system is disclosed in U.S. Pat. No. 7,333,395, the disclosure of which is incorporated herein in its entirety by reference. There are a number of types of lures which mechanically create fish attracting sounds, turbulence, or the like by the movement of parts of the lure as it is drawn through water or by contact of lure parts as it is drawn through water.

### SUMMARY OF THE INVENTION

In general, the present invention provides embodiments of fishing apparatus which employ sound to attract fish and to detect the presence of fish using a transducer or transducers which are located out of water and which are acoustically coupled through a conventional fishing line to locations under water.

The present invention provides embodiments of sonic fishing devices or apparatus including a fishing rod and a fishing line engaged with the rod, a microphonic element acoustically coupled to the fishing line and generating an electrical signal analogous to an acoustic signal impinging the fishing line by contact of a fish therewith; an amplifier connected to the microphonic element and amplifying a signal generated by the acoustic element; and a sound transducer communicating with the amplifier and converting an amplified signal therefrom to an audible signal. The sound transducer may be a speaker, headphones, in-ear earphones, or the like. The fishing line becomes acoustically coupled to the fishing rod, as when the fisherman moves or positions the rod in such a manner as to create tension in the fishing line. When that occurs, the microphone element is acoustically coupled to the fishing line through the fishing rod. The fishing line may have a lure or bait and a hook or hooks connected to an end thereof.

The sonic fishing device may be mounted in an enclosure having an acoustic chamber formed therein which is acoustically coupled by way of the fishing rod to the fishing line. The acoustic chamber is positioned in spaced relation to the microphonic element and has such a shape as to efficiently couple a sound impinging on the fishing line, such as by contact of a fish therewith, to the microphonic element. The enclosure of the device is attached to the fishing rod, as by clamping thereto, such that the enclosure is acoustically coupled to the fishing line by way of the fishing rod.

The sonic fishing device may include a sound source which is acoustically coupled to the fishing line and which may be mounted within the enclosure so that the acoustic chamber efficiently couples sound from the sound source to the fishing line. The sound source generates a fish stimulating sound signal which, when coupled to the fishing line, causes a fish to attempt to take the lure or bait. The sound source may be a sound generator circuit that generates an electrical fish stimulating signal which is coupled to a sound transducer such as a piezoelectric type of device, a small speaker, or other type of sound radiating type of transducer. The fish stimulating sound signal may have signal characteristics, such as certain frequencies, that have been determined to stimulate certain types of fish to be drawn toward the line and strike the lure. Alternatively, the fish stimulating sound signal may be recordings of sounds made by typical prey of the types of fish which are sought.

The device may include a filter connected between the microphonic element and the audio amplifier to prevent the fish stimulating sound from entering the microphonic element and possibly masking sounds generated by contact of a fish with the fishing line. Additionally, the filter may also prevent possible signal feedback through the device.

The sound transducer for hearing the sound of a fish contacting the fishing line may be wirelessly coupled to the sonic fishing device enclosure, for convenience of the fisherman. The sonic fishing device may include a radio-frequency (RF) link between the audio amplifier in the device enclosure and the sound transducer. An enclosure RF transceiver is positioned in the enclosure and is connected to the audio amplifier therein. A sound transducer, or headphone, RF transceiver is connected to a receiver audio amplifier having the headphone or other sound transducer connected thereto. The amplified signal from the enclosure audio amplifier is communicated by the enclosure RF transceiver to the headphone RF transceiver and to the headphone by the receiver audio amplifier. By this means, sound generated by a fish contacting the fishing line is communicated to the headphone over the RF link. The headphone RF transceiver may have a sound selector switch connected thereto to enable the fisherman to select a particular fish stimulating sound to be generated by the sound generator in the device enclosure. A sound selection signal is communicated over the RF link to the sound generator for this purpose.

Various objects and advantages of the present invention will become apparent from the following description taken in conjunction with the accompanying drawings wherein are set forth, by way of illustration and example, certain embodiments of this invention.

The drawings constitute a part of this specification, include exemplary embodiments of the present invention, and illustrate various objects and features thereof.

### BRIEF DESCRIPTION OF THE DRAWINGS

FIG. 1 is a side elevational view of a fishing rod having a sonic fishing device according to the present invention mounted thereon.

FIG. 2 is an enlarged lower perspective view of an enclosure of the sonic fishing device of the present invention.

FIG. 3 is a longitudinal cross sectional view of the sonic fishing device, illustrating component parts housed in the enclosure thereof.

FIG. 4 is a block diagram illustrating functional components of the sonic fishing device of the present invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference number 1 generally designates an embodiment of a sonic fish stimulation and detection device, or sonic fishing device, according to the present invention. The device 1 includes an enclosure or pod 3 which is mounted on a fishing rod 5 having a fishing line 7 attached thereto, typically having a fishing lure or bait 9 attached to an end thereof. The enclosure 3 has circuitry 12 (FIG. 4) mounted therein which is acoustically coupled to the fishing line 7 in such a manner as to communicate a fish stimulating signal toward the end of the fishing line 7 to cause a fish to strike the lure 9 and to detect sounds generated by contact of a fish with the fishing line 7 or lure 9.

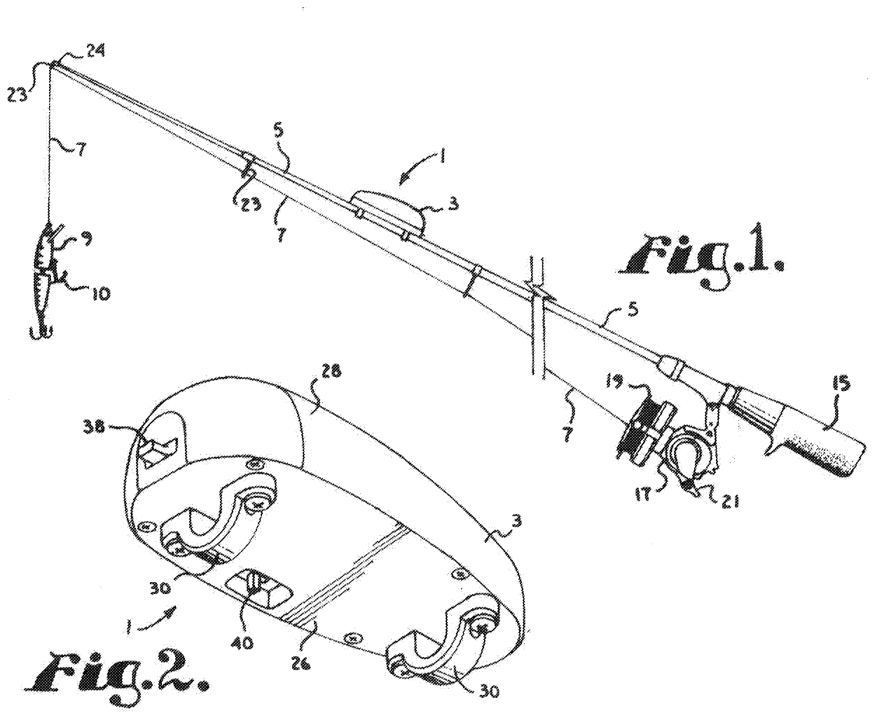

Referring to FIG. 1, the fishing rod 5 may be a conventional type of elongated fishing rod including a fishing rod handle 15 at a proximal or inner end for comfortable gripping of the rod by a fisherman. It is also foreseen that the fishing rod could be other types of rods than as shown, especially a hollow tube rod wherein line passes through the tube. A conventional type of fishing reel device 17 may be mounted on the rod 5 and have a supply of the fishing line 7 wound on a reel 19 thereof. The reel device 17 may include a crank 21 engaged with the reel 19 to enable rotating the reel to wind the line 7 onto the reel. The illustrated rod 5 has fishing line guides 23 spaced therealong toward a distal or outer end 24 of the rod 5 through which the fishing line 17 passes between the reel 19 and the outer rod end. An outer end of the fishing line 7 is tied onto the lure 9, which typically has one or more fishing hooks 10 attached thereto. The rod 9 and reel device 17 cooperate to enable the fisherman to cast the lure 9 to a desired position on a body of water, with the fishing line paying out from the reel 19.

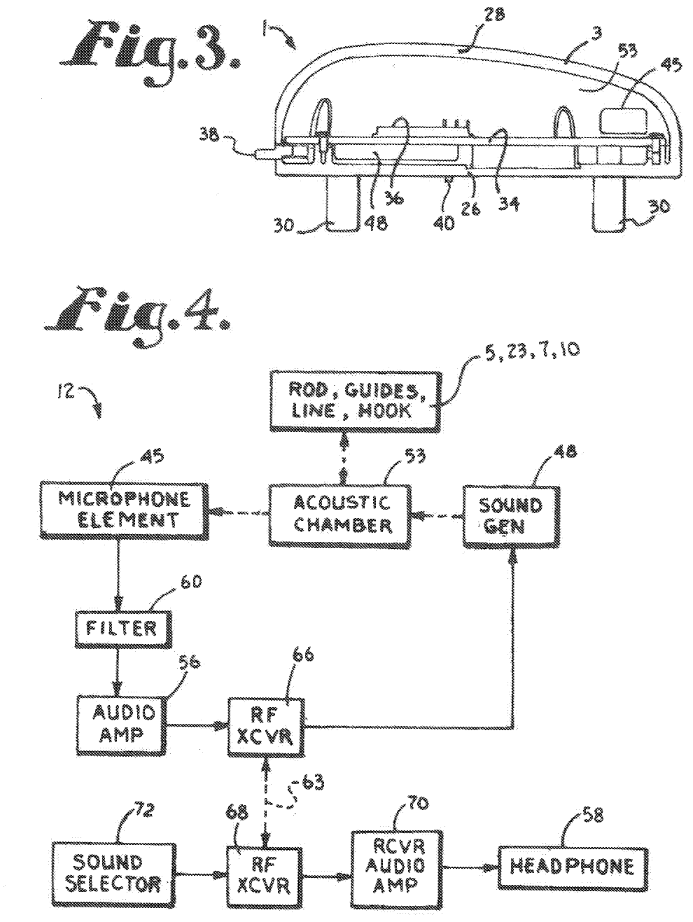

Referring to FIGS. 2 and 3, the illustrated enclosure or pod 3 has a flattened lower wall 26 and a somewhat teardrop, partial egg shape, or pod shaped, curved upper wall 28. The lower wall 26 has a pair of longitudinally spaced clamp members 30 removably fastened to a lower surface thereof, as by screws, to enable mounting of the enclosure 3 on the fishing rod 5. Within the enclosure 3, a circuit board 34 (FIG. 3) is supported on an upper surface of the lower wall 26. The circuit board 34 may be a conventionally formed printed circuit board and has components of the circuitry 12 mounted thereof. Components of the circuitry 12 are interconnected, as necessary, by conductive traces (not shown) formed on and/or within the board 34. The board 34 has a rechargeable battery 36 mounted thereon and interconnected with components of the circuitry 12 to enable operation thereof. The battery 36 may, for example, be a rechargeable lithium ion battery. The illustrated enclosure 30 includes a charging connector or port 38 mounted thereon and connected to the battery 36 to enable selective recharging thereof. The charging connector 38 may be a conventional universal serial bus (USB) connector, such as a Mini-A type of USB connector. The enclosure 3 may include an externally accessible battery switch 40 to selectively connect the battery 36 to the circuitry 12 to activate the circuitry for use.

The enclosure 3 is acoustically coupled to the fishing rod 5 and through the rod 5 and line guides 23 to the fishing line 7, particularly when the rod 5 is held in or moved in such a manner as to make the fishing line 7 taut or tensioned. Thus, sounds generated in the lure 9 or fishing line 7 are acoustically coupled to the enclosure 3 by way of the fishing line 7 and the rod 5 to the enclosure 3.

The illustrated circuitry 12 of the sonic fishing device 1 includes a microphone or microphonic element 45 mounted on the circuit board 34. The microphone 45 is acoustically coupled to the fishing line 7, by way of the rod 5, the fishing line guides 23 and the enclosure 3, whereby sound generated by contact of a fish with the fishing line 7 or lure 9 is acoustically coupled to the microphone 45. The microphone 45 may, for example, be an electret type of microphone, although the use of other types of microphonic elements is foreseen. The illustrated circuitry 12 also includes a sound generator 48 which is mounted on the circuit board 34 and acoustically coupled to the fishing line 7 by way of the enclosure 3, the fishing rod 5, and the line guides 23. The sound generator 48 generates a fish stimulating sound signal which is travels along the line 7 toward the lure 9 to create sounds in the water to cause fish to approach and attempt to take the lure 9. The illustrated sound generator 48 generates a signal having a frequency in a range of about 150 to 2000 Hertz and preferably in the range of 300 to 400 Hertz, which is within the hearing range of certain types of fish.

The sound generator 48 may be one of a number of types of sound generating transducers, such as small speakers, piezoelectric elements, or the like. A particular type of sound generator which would be appropriate is a bone conductor type of transducer of the type which communicates audio content, such as musical content or the like, to the ears of a listener through bones of the skull rather than through the air to the eardrums. An exemplary type of such a transducer is an Adafruit model 1674 bone conductor transducer (www.adafruit.com), or an equivalent type of device. The sound generator 48 may include circuitry (not shown) such as an oscillator and an amplifier to originate and amplify a signal for a transducer thereof. Alternatively, it is foreseen that the sound generator 48 may store recordings of sounds made by prey of the fish to be caught. Such a recording may be amplified within the sound generator 48 and communicated to a transducer thereof.

The upper wall 28 of the illustrated enclosure 3 has a curved inner surface 51 which forms an acoustic chamber 53 within the enclosure which is acoustically coupled to the fishing line 7 through the fishing rod 5 on which the enclosure 3 is mounted. The surface 51 is shaped to efficiently couple sound from the fishing rod 5 to the microphone 45 and to efficiently couple sounds and/or vibrations from the sound generator 48 to the fishing line 7 by way of the fishing rod 5.

The microphone 45 is connected to an audio amplifier 56 to amplify an electrical signal analogous to sounds acoustically coupled generated by the microphone 45. The amplifier 56 may, for example, be an Adafruit Model MAX98306 or Model MAX9814, or an equivalent device. An amplified signal from the amplifier 56 may be communicated to an output transducer 58, such as headphones, an earphone, or the like to enable the fisherman to hear sounds impinging on the fishing line 7 by contact of a fish therewith.

In order to prevent sounds generated by the sound generator 48 from reaching the amplifier 56, and possibly interfering with or masking sounds generated by contact of a fish with the line 7, the circuitry 12 may include a filter 60 connected between the microphone 45 and the amplifier 56. The filter 60 may be a frequency specific type filter, such as a notch filter, a differential type of filter which electrically subtracts an image of the fish stimulating sound from the sound sensed by the microphone 45, or a digital filter which digitally removes sound characteristics of the fish stimulating sound from the sound sensed by the microphone 45. The filter 60 may also function to prevent audio feedback within the circuitry 12.

While the output transducer or headphones 58 may be connected directly to the audio amplifier 56, the illustrated circuitry 12 includes a radio frequency, or RF, link 63 between the audio amplifier 56 and the headphones 58. The circuitry 12 may include an RF device 66 connected to the audio amplifier 56 which is capable of transmitting the amplified signal therefrom to a remote RF device 68 coupled to the output transducer or headphones 58 which is capable of receiving the RF signal from the RF device 66. The RF devices 66 and 68 may, for example, be Bluetooth (trademark of Bluetooth Special Interest Group, Inc. www.bluetooth.com) devices. The RF device 66 may be an Aluratek (www.aluratek.com) Model ABT05F Bluetooth transmitter, or an equivalent device, and the RF device 68 may be an Aluratek Model AIS01F Bluetooth receiver, or an equivalent device. The signal from the remote RF device 68 may be amplified by a receiver audio amplifier 70, the output of which is communicated to the transducer 58. The amplifier 70 may be similar to the audio amplifier 56.

If the sound generator 48 is capable of generating one of a plurality of frequencies or stored recordings of sounds made by prey of the fish to be caught, the circuitry 12 may include a sound selector or selector switch 72 to enable selection of the type of fish stimulating sound to be generated by the sound generator 48. In order to communicate a sound signal selection to the sound generator 48, the sound selector 72 is connected to the RF device 68. Thus, the RF devices 66 and 68 may, alternatively, be RF transceivers, both capable of transmitting or receiving a radio frequency signal, with the RF device being connected to the sound generator 48. A sound selection made by the sound selector 72 is transmitted from the RF device 68, received by the RF device 66, and communicated to the sound generator 48.

It is to be understood that while certain forms of the present invention have been illustrated and described herein, it is not to be limited to the specific forms or arrangement of parts described and shown.

What is claimed as new and desired to be secured by Letters Patent is:

1. In a fishing apparatus including a fishing rod and a fishing line engaged with the rod, the improvement comprising:
(a) a microphonic element acoustically coupled to the fishing line and generating an electrical signal analogous to an acoustic signal impinging the fishing apparatus by contact of a fish therewith;
(b) an amplifier connected to the microphonic element and amplifying a signal generated by the microphonic element; and
(c) a sound transducer communicating with the amplifier and converting an amplified signal therefrom to an audible signal.

2. An apparatus as set forth in claim 1 wherein:
(a) the fishing line is acoustically coupled to a fishing rod; and
(b) the microphonic element is acoustically coupled to the fishing line through the fishing rod.

3. An apparatus as set forth in claim 1 and including:
(a) a fishing rod having the fishing line engaged therewith;
(b) an acoustic chamber mounted on a fishing rod, the acoustic chamber being acoustically coupled to the fishing line; and
(c) the acoustic chamber being mounted in spaced relation to the microphonic element and having such a shape as to efficiently couple the acoustic signal impinging on the fishing line to the microphonic element.

4. An apparatus as set forth in claim 1 and including:
(a) a radio frequency transmitter coupled to the amplifier and transmitting a modulated carrier signal modulated by the amplified signal from the amplifier;
(b) a radio frequency receiver positioned to receive the modulated carrier signal; and
(c) the sound transducer being coupled to the receiver and converting the modulated carrier signal to an audible signal analogous to the acoustic signal impinging the fishing line.

5. An apparatus as set forth in claim 1 and including:
(a) a fishing lure with a hook connected to an end of the fishing line;
(b) a sound source acoustically coupled to the fishing line; and
(c) the sound source generating a fish stimulating sound signal through the fishing line to cause a fish to attempt to take the lure to thereby facilitate catching such a fish.

6. An apparatus as set forth in claim 5 and including:
(a) an acoustic chamber mounted on a fishing rod and acoustically coupled to the fishing line; and
(b) the acoustic chamber being mounted in spaced relation to the sound source and having such a shape as to efficiently couple the fish stimulating sound signal from the sound source to the fishing line.

7. An apparatus as set forth in claim 6 and including:
(a) a filter connected between the microphonic element and the amplifier, the filter being configured to prevent the fish stimulating sound signal from being amplified by the amplifier.

8. A fishing apparatus comprising:
(a) a fishing rod having a fishing line engaged therewith and capable of being acoustically coupled therewith;
(b) a microphonic element mounted on the fishing rod acoustically coupled therewith and generating an electrical signal analogous to an acoustic signal impinging the fishing apparatus by contact of a fish with the fishing apparatus;
(c) an amplifier connected to the microphonic element and amplifying a signal generated by the microphonic element; and
(d) a sound transducer communicating with the amplifier and converting an amplified signal therefrom to an audible signal.

9. An apparatus as set forth in claim 8 and including:
(a) an acoustic chamber mounted on a fishing rod, the acoustic chamber being acoustically coupled to the fishing line; and
(b) the acoustic chamber being mounted in spaced relation to the microphonic element and having such a shape as to efficiently couple the acoustic signal impinging on the fishing line to the microphonic element.

10. An apparatus as set forth in claim 8 and including:
(a) a radio frequency transmitter coupled to the amplifier and transmitting a modulated carrier signal modulated by the amplified signal from the amplifier;
(b) a radio frequency receiver positioned to receive the modulated carrier signal; and
(c) the sound transducer being coupled to the receiver and converting the modulated carrier signal to an audible signal analogous to the acoustic signal impinging the fishing line.

11. An apparatus as set forth in claim 8 and including:
(a) a fishing lure with a hook connected to an end of the fishing line;
(b) a sound source acoustically coupled to the fishing line; and
(c) the sound source generating a fish stimulating sound signal to cause a fish to attempt to take the lure to thereby facilitate hooking such a fish.

12. An apparatus as set forth in claim 11 and including:
(a) an acoustic chamber mounted on a fishing rod, the acoustic chamber being acoustically coupled to the fishing line; and
(b) the acoustic chamber being mounted in spaced relation to the sound source and having such a shape as to efficiently couple the fish stimulating sound signal from the sound source to the fishing line.

13. An apparatus as set forth in claim 12 and including:
(a) a filter connected between the microphonic element and the amplifier, the filter being configured to prevent the fish stimulating sound signal from being amplified by the amplifier.

14. A fishing apparatus comprising:
(a) a fishing rod having a fishing line engaged therewith and capable of being acoustically coupled therewith;
(b) a microphonic element mounted on the fishing rod, acoustically coupled therewith, and generating an electrical signal analogous to an acoustic signal impinging the fishing apparatus by contact of a fish with the fishing apparatus;
(c) an amplifier connected to the microphonic element and amplifying a signal generated by the acoustic element;
(d) a sound source acoustically coupled to the fishing line, the sound source being capable of generating a fish stimulating sound signal to cause a fish to attempt to take the lure to thereby facilitate hooking such a fish;
(e) an acoustic chamber mounted on a fishing rod, the acoustic chamber being acoustically coupled to the fishing line;
(f) the acoustic chamber being mounted in spaced relation to the microphonic element and having such a shape as to efficiently couple the acoustic signal impinging on the fishing line to the microphonic element;
(g) the acoustic chamber also being mounted in spaced relation to the sound source to thereby efficiently couple the fish stimulating sound signal to the fishing line by way of the fishing rod; and
(h) a sound transducer communicating with the amplifier and converting an amplified signal therefrom to an audible signal.

15. An apparatus as set forth in claim 14 and including:
(a) a radio frequency transmitter coupled to the amplifier and transmitting a modulated carrier signal modulated by the amplified signal from the amplifier;
(b) a radio frequency receiver positioned to receive the modulated carrier signal; and
(c) the sound transducer being coupled to the receiver and converting the modulated carrier signal to an audible signal analogous to the acoustic signal impinging the fishing line.

16. An apparatus as set forth in claim 14 and including:
(a) a filter connected between the microphonic element and the amplifier, the filter being configured to prevent the fish stimulating sound signal from being amplified by the amplifier.

17. A fishing apparatus comprising:
(a) a fishing rod having a fishing line engaged therewith and capable of being acoustically coupled therewith;
(b) a microphonic element mounted on the fishing rod, acoustically coupled therewith, and generating an electrical signal analogous to an acoustic signal impinging the fishing apparatus by contact of a fish with the fishing apparatus;
(c) an amplifier connected to the microphonic element and amplifying a signal generated by the acoustic element; and
(d) a sound source acoustically coupled to the fishing line, the sound source being capable of generating a fish stimulating sound signal to cause a fish to attempt to take the lure to thereby facilitate hooking such a fish.
